(19) United States
(12) Patent Application Publication
(10) Pub. No.: US 2025/0381857 A1
(43) Pub. Date: Dec. 18, 2025

(54) VEHICLE BODY STRUCTURE

(71) Applicants: Hyundai Motor Company, Seoul (KR); Kia Corporation, Seoul (KR)

(72) Inventor: ChangHak Kang, Hwaseong-si (KR)

(21) Appl. No.: 18/960,986

(22) Filed: Nov. 26, 2024

(30) Foreign Application Priority Data
Jun. 18, 2024 (KR) 10-2024-0078733

(51) Int. Cl. B60L 50/71; B60K 15/03; B60K 15/063; B60K 15/067; B62D 21/03; B62D 25/02; B62D 25/20; H01M 8/04082

(52) U.S. Cl. CPC B60L 50/71; B60K 15/067; B62D 21/03; B62D 25/025; B62D 25/20; H01M 8/04201; B60K 2015/03315; B60K 2015/0638; H01M 2250/20

(57) ABSTRACT

An embodiment vehicle body includes a center floor assembly, a side sill disposed along a front-rear direction of the vehicle body on both sides of the center floor assembly in a vehicle width direction and connected to a front body assembly, a fuel cell stack mounting apparatus disposed at a front portion of the center floor assembly and configured to position fuel cell stacks at a lower portion of the center floor assembly, and a hydrogen tank mounting apparatus disposed at a rear of the center floor assembly and configured to position hydrogen tanks at the lower portion of the center floor assembly.

### CROSS-REFERENCE TO RELATED APPLICATIONS

This application claims the benefit of Korean Patent Application No. 10-2024-0078733, filed on Jun. 18, 2024, which application is hereby incorporated herein by reference.

### TECHNICAL FIELD

An embodiment relates to a vehicle body structure.

### BACKGROUND

In general, the development and demand for environmentally friendly vehicles are increasing as the discharge reference of oxidation carbon is strengthened.

Examples of environmentally friendly vehicles include hybrid vehicles, electric vehicles, hybrid electric vehicles, and hydrogen electric vehicles (commonly referred to as a ‘hydrogen power vehicle’ by a person of ordinary skill in the art).

Among these, various parts such as a high voltage battery, fuel cell stack, drive motor, hydrogen tank, and cooling module are mounted on the vehicle body of a hydrogen electric vehicle.

Recently, hydrogen electric vehicle-based commercial vehicles and even light commercial vehicles (LCVs) are being introduced.

LCV here refers to a type of commercial vehicle used in Europe, Australia, Canada, etc., and in principle refers to a medium-sized commercial vehicle with a gross weight of less than 3.5 tons.

However, such hydrogen electric vehicle-based LCVs have difficulties mounting large-capacity hydrogen tanks and high-power fuel cell stacks in the limited space of the vehicle body. Additionally, hydrogen electric vehicle-based LCVs may cause damage to various parts in the event of a vehicle collision.

The information contained in this background section has been prepared to promote understanding of the background of embodiments of the invention and may include matters that are not already known prior art.

### SUMMARY

An embodiment relates to a vehicle body structure. Particular embodiments relate to a vehicle body structure of a hydrogen electric vehicle.

Embodiments of the present disclosure provide a vehicle body structure that can secure a space for mounting a hydrogen tank and a fuel cell stack and secure the mount strength and collision performance of the hydrogen tank and fuel cell stack.

A vehicle body structure may be configured to mount fuel cell stacks and hydrogen tanks on a center floor assembly. The vehicle body structure according to an embodiment may include a side sill arranged along the front-rear direction of the vehicle body on both sides of the center floor assembly in the vehicle width direction and connected to a front body assembly, a fuel cell stack mounting unit provided at the front portion of the center floor assembly to place the fuel cell stacks at the lower portion of the center floor assembly, and a hydrogen tank mounting unit provided at the rear of the center floor assembly to place the hydrogen tanks at the lower portion of the center floor assembly.

The vehicle body structure according to an embodiment may further include a stack mount module connected to the front body assembly, the side sill, and the hydrogen tank mounting unit to mount the fuel cell stacks to the fuel cell stack mounting unit, and a tank mount module connected to the stack mount module and the hydrogen tank mounting unit to mount the hydrogen tanks on the hydrogen tank mounting unit.

The fuel cell stack mounting unit may include a seat mounting member connected to a front side rear lower member connected to the front side member of the front body assembly and the side sill.

The hydrogen tank mounting unit may include a center floor panel connected to the seat mounting member and the side sill and a plurality of center cross members arranged along the vehicle width direction at predetermined intervals on the lower surface of the center floor panel and connected to the side sill.

The seat mounting member may be positioned between the front cross member and the center cross members along the vehicle width direction in the front body assembly.

The seat mounting member may include a front flange portion connected to a dash panel and the front side rear lower member of the front body assembly, a rear flange portion connected to the center floor panel, and a seat mounting portion formed between the front flange portion and the rear flange portion.

A fuel cell stack mount space may be formed at the bottom of the seat mounting member.

A hydrogen tank mount space may be formed between the lower surface of the center floor panel and the center cross members.

The seat mounting member may be connected to the front side rear lower member, which is arranged in a ‘V’ shape along the front-rear direction of the vehicle body.

The stack mount module may include a pair of transverse direction support trays arranged along the vehicle width direction at predetermined intervals on the lower side of the fuel cell stack mounting unit and engaging the side sill and a longitudinal direction support tray arranged along the front-rear direction of the vehicle body, connected to the upper portion of the transverse direction support trays, and engaged with the front body assembly and the hydrogen tank mounting unit.

The transverse direction support trays and the longitudinal direction support tray may be arranged in an ‘H’ shape and may be connected by welding.

Each of the transverse direction support trays may include a transverse direction lower member and a transverse direction upper member connected by welding along the vertical direction to form a closed space.

The longitudinal direction support tray may include a longitudinal direction lower member and a longitudinal direction upper member connected by welding along the vertical direction to form a closed space.

The front part of the longitudinal direction support tray may be connected to the transverse direction support tray placed in the front by welding.

The rear part of the longitudinal direction support tray may be connected to the transverse direction support tray placed at the rear by welding.

The front connecting parts of the longitudinal direction support tray and the transverse direction support tray may engage with the front side rear lower member connected to the front side member of the front body assembly.

The rear connecting part of the longitudinal direction support tray and the transverse direction support tray may engage with the center cross member provided in the hydrogen tank mounting unit.

The stack mount module may include a stack mounting portion each partitioned by the transverse direction support trays and the longitudinal direction support tray.

Each of the fuel cell stacks may be placed on the stack mounting portion and may engage the flanges of the transverse direction support trays.

The tank mount module may include a plurality of strap band clampers connected to the stack mount module and connected to the center cross member provided on the hydrogen tank mounting unit.

The tank mount module may further include a clamper support member connected to the strip band clampers and connected to the center cross member.

Embodiments of the present disclosure enable the construction of a hydrogen electric vehicle-based LCV without increasing the height of the vehicle body, by securing space to mount high-capacity fuel cell stacks and large-capacity hydrogen tanks.

In addition, any effects that can be obtained or expected due to embodiments are directly or implicitly disclosed in the detailed description of the embodiments. That is, various effects predicted according to the embodiments will be disclosed in the detailed description that follows.

### BRIEF DESCRIPTION OF THE DRAWINGS

Embodiments of this specification may be better understood by reference to the following description taken in conjunction with accompanying drawings in which similar reference symbols designate identical or functionally similar elements.

FIG. 1 is a side view illustrating a vehicle body structure according to an embodiment.

FIG. 2 is a bottom view illustrating a vehicle body structure according to an embodiment.

FIG. 3 and FIG. 4 are perspective views illustrating a vehicle body structure according to an embodiment.

FIG. 5 and FIG. 6 are partially exploded perspective views illustrating a vehicle body structure according to an embodiment.

FIG. 7 to FIG. 9 illustrate a stack mount module and a tank mount module applied to a vehicle body structure according to an embodiment.

FIG. 10 illustrates a stack mount module and a tank mount module applied to a vehicle body structure according to an embodiment.

FIG. 11 illustrates the connected structure of a stack mount module and a fuel cell stack applied to a vehicle body structure according to an embodiment.

The following reference identifiers may be used in connection with the drawings to describe various features of embodiments of the present invention.

| | |
|---|---|
| 1: hydrogen tank | 3: fuel cell stack |
| 11: front body assembly | 12: front side member |
| 13: fender apron member | 14: dash panel |
| 15: front cross member | 16: front side rear lower member |
| 21: center floor assembly | 23: side sill |
| 31: rear floor assembly | 33: rear under body |
| 35: rear floor panel | 40: fuel cell stack mounting unit |
| 41: seat mounting member | 42: fuel cell stack mount space |
| 43: front flange portion | 45: rear flange portion |
| 47: seat mounting portion | 50: hydrogen tank mounting unit |
| 51: center floor panel | 53: center cross member |
| 57: hydrogen tank mount space | 70: stack mount module |
| 70a: pipe spacer | 71: transverse direction support tray |
| 73a: transverse direction lower member | 73b: transverse direction upper member |
| 74, 78: closed space | 75: longitudinal direction support tray |
| 76a: front connecting part | 76b: rear connecting part |
| 77a: longitudinal direction lower member | 77b: longitudinal direction upper member |
| 79: stack mounting portion | 79a: flange |
| 80: tank mount module | 81: strap band clamper |
| 83: connecting member | 85: clamper support member |
| 91, 92, 93, 94, 95, 96: fastening member | 99: load path |
| 100: vehicle body structure | |

It should be understood that the drawings referenced above are not necessarily drawn to scale, but rather present rather simplified representations of various preferred features illustrating the basic principles of embodiments of the present invention.

For example, certain design features of embodiments of the present disclosure, including particular dimensions, directions, positions, and shapes, will be determined in part by the particular intended application and usage environment.

### DETAILED DESCRIPTION OF ILLUSTRATIVE EMBODIMENTS

The terminology used in this specification is for the purpose of describing particular embodiments and is not intended to limit the present disclosure.

As used in this specification, the singular form is intended to also include the plural forms, unless the context clearly indicates otherwise.

It should also be understood that the terms “comprises” and/or “comprising” as used herein indicate the presence of stated features, integers, steps, operations, elements, and/or components, but do not preclude the presence or addition of one or more other features, integers, steps, operations, components, and/or groups thereof.

As used in this specification, the term ‘and/or’ includes any one or all combinations of one or more of the associated listed items.

The term “connected” in this specification indicates a physical relationship between two components in which the components are directly connected to each other by welding, rivets, self-piercing rivets (SPRs), flow drill screws (FDSs), structural adhesives, etc., or indirectly connected through one or more intermediate components.

The terms ‘vehicle’, ‘vehicular’, ‘automobile’ or other similar terms used in this specification generally include passenger automobiles, including sports cars, sport utility vehicles (SUVs), buses, trucks, and various commercial vehicles.

Additionally, it may include hybrid vehicles, electric vehicles, hybrid electric vehicles, hydrogen electric vehicles, electric-based purpose-built vehicles (PBVs), hydrogen electric-based LCVs and other alternative fuel vehicles (e.g., fuel derived from resources other than petroleum).

Hereinafter, embodiments of the present disclosure are described in detail with reference to the accompanying drawings.

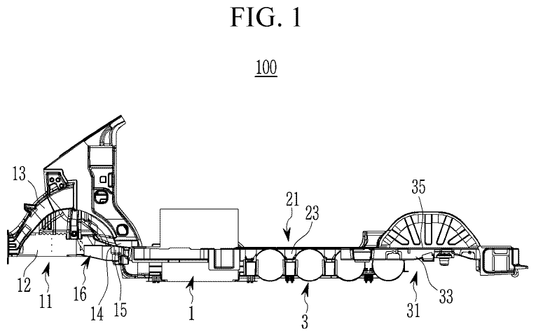

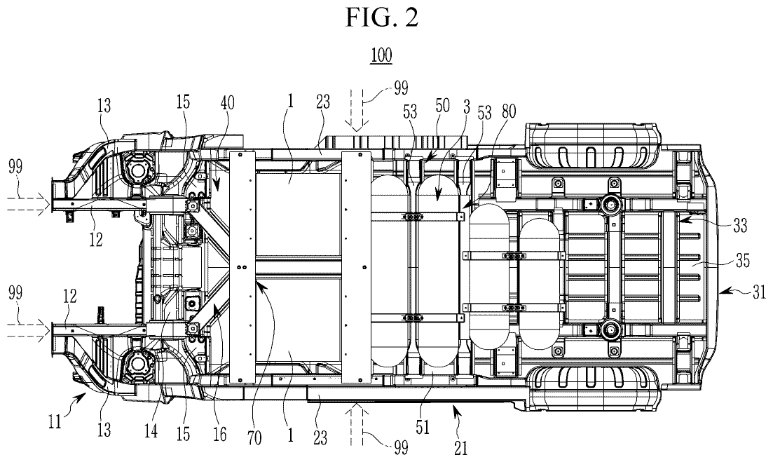

FIG. 1 is a side view illustrating a vehicle body structure according to an embodiment, and FIG. 2 is a bottom view illustrating a vehicle body structure according to an embodiment.

Referring to FIG. 1 and FIG. 2, a vehicle body structure 100 according to an embodiment may be applied to a vehicle body of a hydrogen electric vehicle.

The vehicle body structure 100 according to an embodiment may be applied to a vehicle body of a hydrogen electric vehicle-based light commercial vehicle (LCV).

The LCV here could be manufactured as a 1.5 box design with a semi-bonnet rather than a 1 box design with a cab over, for example.

The vehicle body of the LCV may accommodate various components such as a high voltage battery (not shown), fuel cell stacks 1, hydrogen tanks 3, drive motor (not shown), inverter (not shown), and cooling module (not shown).

The vehicle body structure 100 according to an embodiment is configured to mount the fuel cell stacks 1 and the hydrogen tanks 3 on the vehicle body of a hydrogen electric vehicle-based LCV.

Alternatively, the vehicle body structure 100 according to an embodiment is not limited to being applied to a vehicle body of an LCV, but may also be applied to a vehicle body of a van vehicle transporting occupants (e.g., a hailing vehicle or a high roof vehicle).

In this specification, the reference direction for explaining the components below may be set as the front-rear direction of the body (e.g., body length direction), the width direction (e.g., left-right direction), and the up-down direction (e.g., height direction) based on the body.

In this specification, the ‘upper part’, ‘upper portion’, ‘top’ or ‘upper surface’ of a component indicates an end, section, or surface of the component that is relatively upper in the drawing, and the ‘lower part’, ‘lower portion’, or ‘lower surface’ of a component indicates an end, section, or surface of the component that is relatively lower in the drawing.

Additionally, in the specification, the term “end” of a component (e.g., one end, the other end, or both ends, etc.) indicates an end of the component in any one direction, and the term “end portion” of a component (e.g., one end portion, the other end portion, both end portions, a front end portion, or a rear end portion, etc.) indicates a portion of the component that includes that end.

The vehicle body structure 100 according to an embodiment includes a front body assembly 11, a center floor assembly 21, and a rear floor assembly 31 connected to each other along the front-rear direction of the vehicle body.

The front body assembly 11 is positioned at the front of the vehicle body.

The front body assembly 11 includes front side members 12 arranged along the front-rear direction of the vehicle body on each side along the vehicle width direction.

The front body assembly 11 includes a fender apron member 13 and a dash panel 14 connected to the front side member 12.

The front body assembly 11 includes a front cross member 15 positioned along the vehicle width direction on the rear lower surface of the dash panel 14.

The front body assembly 11 includes a front side rear lower member 16 connected along the front-rear direction of the vehicle body to the rear of the front side member 12.

In an embodiment, the front side rear lower member 16 is arranged in a ‘V’ shape at the lower portion of the front body assembly 11.

That is, the front side rear lower member 16 may be connected in a ‘V’ shape along the front-back direction of the vehicle body to the rear portion of the front side members 12 arranged on each side along the vehicle width direction.

The center floor assembly 21 is configured to mount the fuel cell stacks 1 and the hydrogen tanks 3.

The center floor assembly 21 is connected to the front body assembly 11 along the front-rear direction of the vehicle body.

The center floor assembly 21 includes side sills 23.

The side sills 23 are arranged along the front-rear direction of the vehicle body on both sides of the center floor assembly 21 in the vehicle width direction and are connected to the front body assembly 11.

The rear floor assembly 31 is connected to the center floor assembly 21 along the front-rear direction of the vehicle body.

The rear floor assembly 31 includes a rear under body 33 connected along the front-rear direction of the vehicle body with the side sill 23 and a rear floor panel 35 connected to the rear under body 33.

The vehicle body structure 100 according to an embodiment provides a structure capable of securing a space for mounting the fuel cell stacks 1 and the hydrogen tanks 3.

Additionally, the vehicle body structure 100 according to an embodiment may provide a structure capable of securing mount strength and collision performance of the fuel cell stacks 1 and the hydrogen tanks 3.

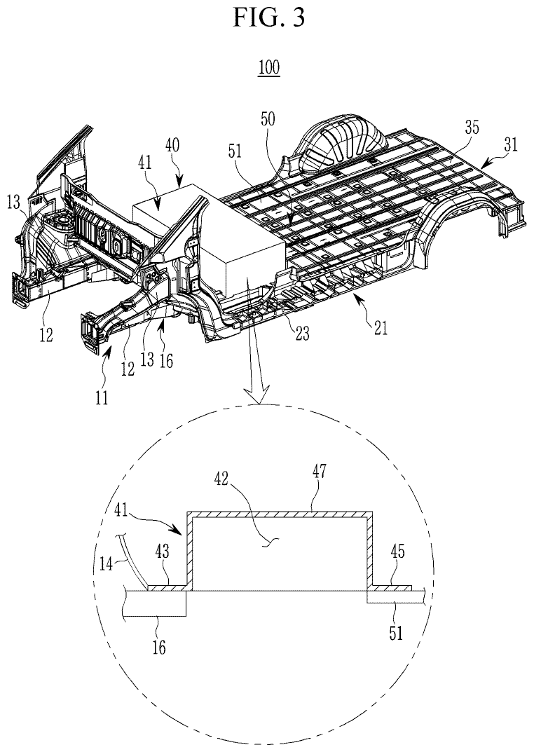

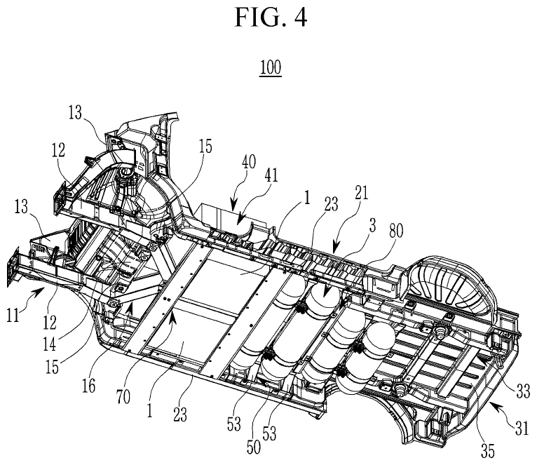

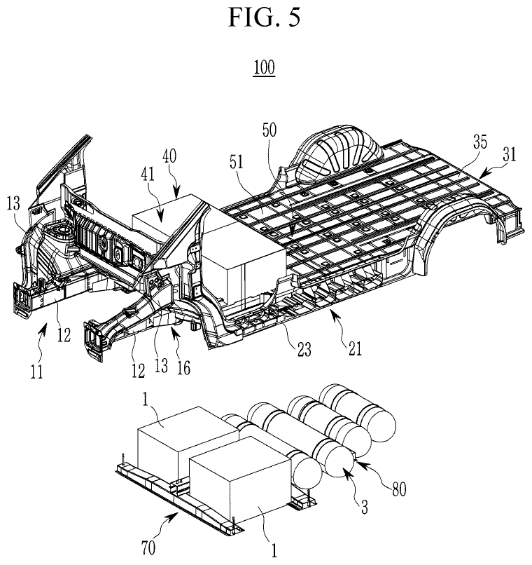

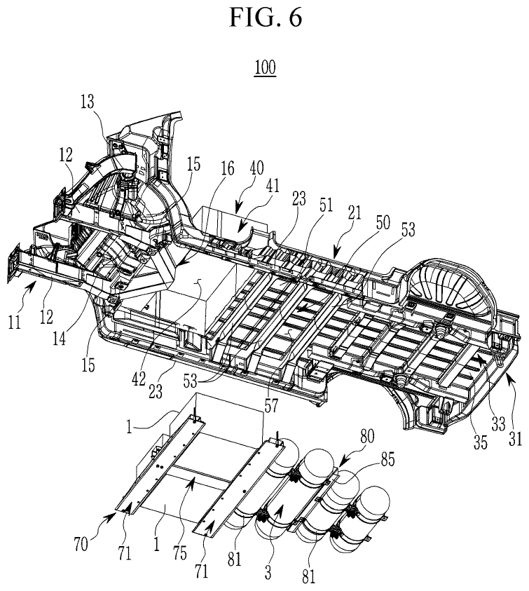

FIG. 3 and FIG. 4 are perspective views illustrating a vehicle body structure according to an embodiment, and FIG. 5 and FIG. 6 are partially exploded perspective views illustrating a vehicle body structure according to an embodiment.

Referring to FIG. 2 to FIG. 6, the vehicle body structure 100 according to an embodiment includes a fuel cell stack mounting unit 40, a hydrogen tank mounting unit 50, a stack mount module 70, and a tank mount module 80.

In an embodiment, the fuel cell stack mounting unit 40 is configured to place the fuel cell stacks 1 on the lower portion of the center floor assembly 21.

The fuel cell stack mounting unit 40 is installed at the front of the center floor assembly 21 and is connected to the front body assembly 11.

The fuel cell stack mounting unit 40 includes a seat mounting member 41.

In an embodiment, the hydrogen tank mounting unit 50 is configured to place the hydrogen tanks 3 on the lower portion of the center floor assembly 21.

The hydrogen tank mounting unit 50 is installed at the rear of the center floor assembly 21 and is connected to the fuel cell stack mounting unit 40 and the rear floor assembly 31.

The hydrogen tank mounting unit 50 includes a center floor panel 51 and a plurality of center cross members 53.

Hereinafter, the configuration of the fuel cell stack mounting unit 40 and the hydrogen tank mounting unit 50 according to an embodiment configured as described above will be specifically described.

The seat mounting member 41 of the fuel cell stack mounting unit 40 according to an embodiment is connected to the front side rear lower member 16, which is arranged in a V shape at the lower part of the front body assembly 11, along the front-rear direction of the vehicle body.

The seat mounting member 41 is connected to the side sill 23.

The seat mounting member 41 is configured to mount a front seat (also commonly referred to as a ‘first row seat’ by a person of ordinary skill in the art) located at the front of the center floor assembly 21.

In one example, the seat mounting member 41 may be formed into a dome shape.

For example, the seat mounting member 41 may be formed into a square dome shape.

The front seat may be mounted on the upper part of the seat mounting member 41 using a seat mounting bracket, etc.

The seat mounting member 41 is positioned between the front cross member 15 of the front body assembly 11 and the center cross members 53 of the hydrogen tank mounting unit 50.

The seat mounting member 41 is provided in a dome shape, and a fuel cell stack mount space 42 is formed at the bottom of the seat mounting member 41.

The seat mounting member 41 includes a front flange portion 43, a rear flange portion 45, and a seat mounting portion 47 (see FIG. 3).

The front flange portion 43 is formed at the front portion of the seat mounting member 41 and may be connected by welding to the front side rear lower member 16 of the front body assembly 11 and the dash panel 14.

The rear flange portion 45 is formed at the rear of the seat mounting member 41 and may be connected to the center floor panel 51 mentioned above.

The seat mounting portion 47 is positioned between the front flange portion 43 and the rear flange portion 45 and is connected to the front flange portion 43 and the rear flange portion 45.

The seat mounting portion 47 may, in one example, be formed in the dome shape of a quadrangle.

The fuel cell stack mount space 42 mentioned above is formed at the lower part (or inside) of the seat mounting portion 47, and the fuel cell stacks 1 may be arranged (or mounted) along the vehicle width direction in the fuel cell stack mount space 42.

The center floor panel 51 of the hydrogen tank mounting unit 50 according to an embodiment is connected to the rear flange portion 45 of the seat mounting member 41 by welding.

The center floor panel 51 is connected to the side sill 23 by welding as mentioned above.

The center floor panel 51 is connected to the rear floor panel 35 of the rear floor assembly 31 by welding.

That is, the front part of the center floor panel 51 is connected to the seat mounting member 41, and the rear part of the center floor panel 51 is connected to the rear floor panel 35.

Additionally, the center cross members 53 of the hydrogen tank mounting unit 50 are configured to reinforce the strength of the center floor panel 51.

The center cross members 53 are arranged at predetermined intervals along the front-rear direction of the vehicle body on the lower surface of the center floor panel 51.

The center cross members 53 are arranged along the vehicle width direction and are connected to the side sills 23.

These center cross members 53 are connected by welding to the lower surface of the center floor panel 51 and to the side sill 23.

A hydrogen tank mount space 57 is formed between the lower surface of the center floor panel 51 and the center cross members 53.

The hydrogen tank mount space 57 may accommodate the hydrogen tanks 3 positioned (or mounted) along the front-rear direction of the vehicle body.

Referring to FIG. 2 to FIG. 6, in an embodiment, the stack mount module 70 is configured to mount the fuel cell stacks 1 to the fuel cell stack mounting unit 40.

The stack mount module 70 is connected to the front body assembly 11, the side sill 23, and the hydrogen tank mounting unit 50.

In an embodiment, the tank mount module 80 is configured to mount the hydrogen tanks 3 to the hydrogen tank mounting unit 50.

The tank mount module 80 is connected to the stack mount module 70 and the hydrogen tank mounting unit 50.

The configuration of the stack mount module 70 and the tank mount module 80 according to an embodiment and the vehicle body mounting structure are described in detail with reference to the accompanying drawing.

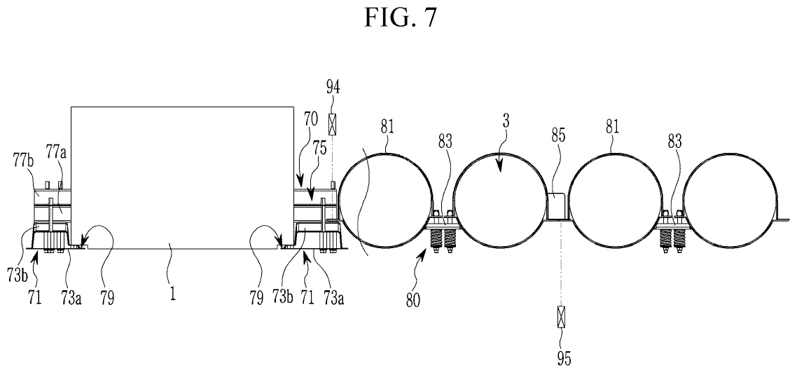

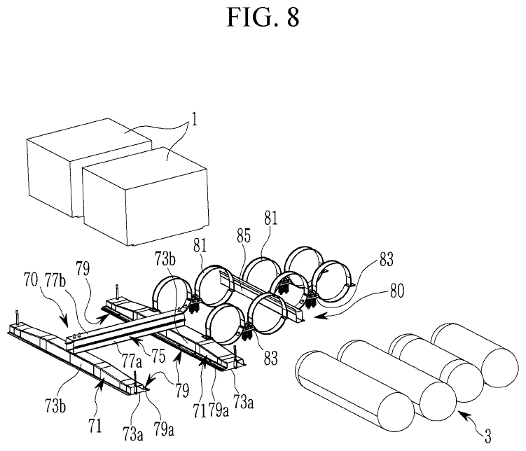

FIG. 7 to FIG. 9 illustrate a stack mount module and a tank mount module applied to a vehicle body structure according to an embodiment.

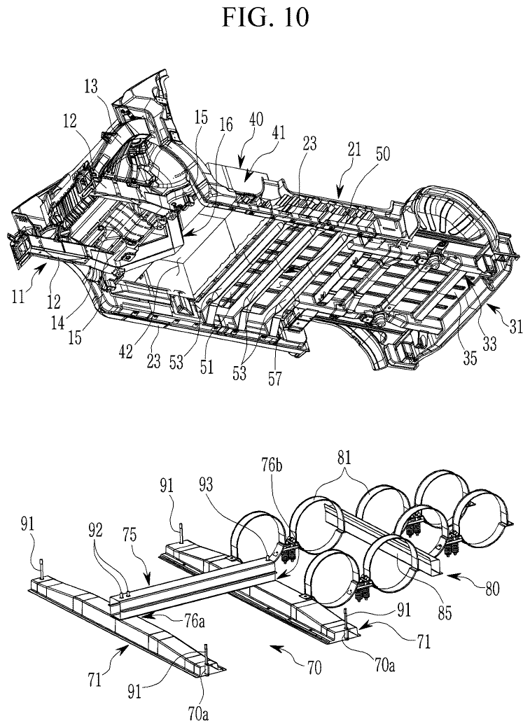

FIG. 10 illustrates a stack mount module and a tank mount module applied to a vehicle body structure according to an embodiment.

Referring to FIG. 6 to FIG. 10, the stack mount module 70 according to an embodiment includes a pair of transverse direction support trays 71 and a longitudinal direction support tray 75.

The transverse direction support trays 71 are arranged along the vehicle width direction at predetermined intervals along the vehicle body forward-backward direction on the lower side of the fuel cell stack mounting unit 40 and connected to the side sill 23.

Each of the transverse direction support trays 71 includes a transverse direction lower member 73a and a transverse direction upper member 73b connected along the vertical direction.

The transverse direction lower member 73a is provided in the form of a flat plate.

The transverse direction upper member 73b is provided in a form formed in the upper direction.

The transverse direction lower member 73a and the transverse direction upper member 73b are connected by welding along the vertical direction.

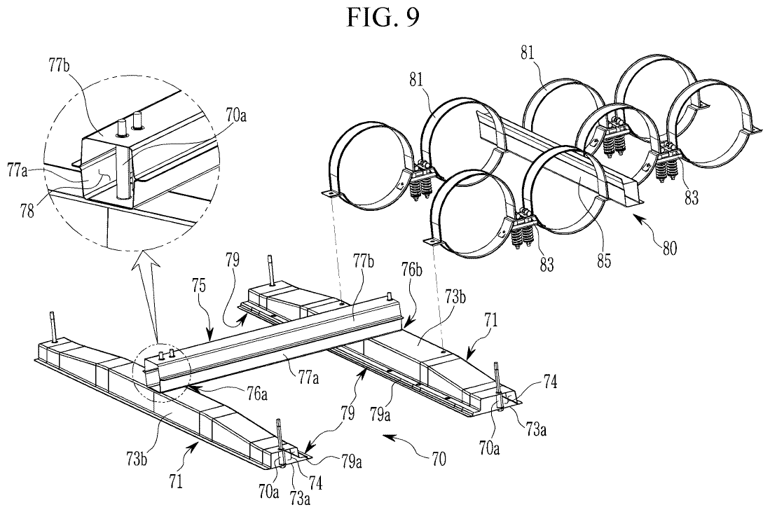

Each of the transverse direction support trays 71 includes a closed space 74 (see FIG. 9) formed by connecting the transverse direction lower member 73a and the transverse direction upper member 73b.

The longitudinal direction support tray 75 is arranged along the front-rear direction of the vehicle body at the lower side of the fuel cell stack mounting unit 40 and is connected to the upper portion of the transverse direction support trays 71.

For example, the longitudinal direction support tray 75 may be connected to the upper part of the transverse direction support trays 71 by welding.

The longitudinal direction support tray 75 engages the front body assembly 11 and the hydrogen tank mounting unit 50.

The longitudinal direction support tray 75 includes a longitudinal direction lower member 77a and a longitudinal direction upper member 77b connected along the vertical direction.

The longitudinal direction lower member 77a is provided in a form formed in the downward direction, and the longitudinal direction upper member 77b is provided in a form formed in the upward direction.

The longitudinal direction lower member 77a and the longitudinal direction upper member 77b are connected by welding along the vertical direction.

The longitudinal direction support tray 75 includes a closed space 78 (see FIG. 9) formed by the combination of the longitudinal direction lower member 77a and the longitudinal direction upper member 77b.

The transverse direction support trays 71 and the longitudinal direction support trays 75 are arranged in an ‘H’ shape.

The front part of the longitudinal direction support tray 75 is connected by welding to the upper part of the transverse direction support tray 71 arranged on the front side.

The rear part of the longitudinal direction support tray 75 is connected by welding to the upper part of the transverse direction support tray 71 arranged on the rear side.

Hereinafter, the connecting part of the front part of the longitudinal direction support tray 75 and the transverse direction support tray 71 are referred to as a front connecting part 76a (see FIG. 9).

The connecting part of the rear part of the longitudinal direction support tray 75 and the transverse direction support tray 71 are called a rear connecting part 76b (see FIG. 9).

The stack mount module 70 includes a plurality of pipe spacers 70a (see FIG. 9) disposed along the vertical direction inside space formed by connecting the transverse direction support trays 71 and the longitudinal direction support tray 75.

The pipe spacers 70a penetrate the upper and lower parts of the transverse direction support trays 71 and the longitudinal direction support tray 75 and may be connected to the upper and lower parts by welding.

The stack mount module 70 includes a stack mounting portion 79 (see FIG. 7 to FIG. 9) each partitioned by the transverse direction support trays 71 and the longitudinal direction support trays 75.

The stack mounting portion 79 is configured to mount the fuel cell stacks 1 to the stack mount module 70.

The stack mounting portion 79 may, in one example, include a flange 79a formed on opposite sides of the transverse direction support trays 71.

The stack mount module 70 engages the side sill 23 via the transverse direction support trays 71, as shown in FIG. 10.

The two ends of the transverse direction support trays 71 along the vehicle width direction may be engaged to the side sill 23 by a fastening member 91 including a combination of bolts and nuts.

The fastening member 91 may engage both ends of the transverse direction support trays 71 and the side sill 23 via the pipe spacers 70a mentioned above.

Additionally, the stack mount module 70 engages the front side rear lower member 16 of the front body assembly 11 via the front connecting part 76a mentioned above.

For example, the front connecting part 76a may be connected to the rear of the front side rear lower member 16 in a vertical direction.

The stack mount module 70 may be connected to any one of the center cross members 53 of the hydrogen tank mounting unit 50 via the rear connecting part 76b mentioned above.

For example, the rear connecting part 76b may be connected along the vertical direction to the center cross member 53 positioned at the front side among the center cross members 53.

The front connecting part 76a may be engaged along the vertical direction with the front side rear lower member 16 by a fastening member 92 including a combination of a bolt and a nut.

The fastening member 92 penetrates the transverse direction support tray 71 and the longitudinal direction support tray 75 of the front connecting part 76a through the pipe spacers 70a and may engage the front connecting part 76a and the front side rear lower member 16.

The rear connecting part 76b may be engaged along the vertical direction with the center cross member 53 by a fastening member 93 including a combination of a bolt and a nut.

The fastening member 93 penetrates the transverse direction support tray 71 and the longitudinal direction support tray 75 of the rear connecting part 76b through the pipe spacers 70a and may engage the rear connecting part 76b and the center cross member 53.

Referring to FIG. 6 to FIG. 10, the tank mount module 80 according to an embodiment includes a plurality of strap band clampers 81 and a clamper support member 85.

The strap band clampers 81 are configured to clamp the hydrogen tanks 3 to the stack mount module 70 and the hydrogen tank mounting unit 50.

The strap band clampers 81 are connected to the stack mount module 70, which is connected to one of the center cross members 53 of the hydrogen tank mounting unit 50.

The strap band clampers 81 may be interconnected by a plurality of connecting members 83.

The strap band clampers 81 may be engaged with the transverse direction support tray 71 on the rear side of the stack mount module 70 by a fastening member 94 including a combination of bolts and nuts (see FIG. 7).

The clamper support member 85 is connected to the strap band clampers 81 separately from the connecting members 83 and may be connected to one of the center cross members 53 by welding or engaging.

The above clamper support member 85 may be engaged with the strap band clampers 81 by a fastening member 95 including a combination of a bolt and a nut (see FIG. 7).

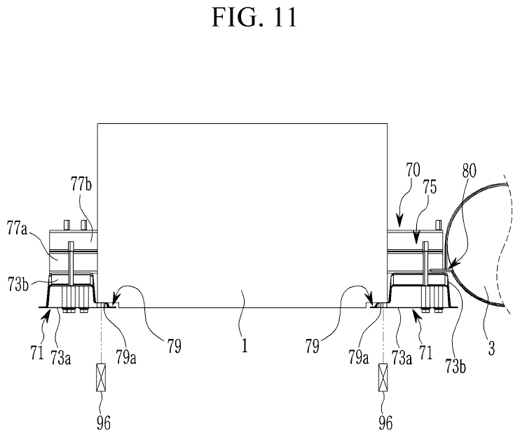

FIG. 11 illustrates the connected structure of a stack mount module and a fuel cell stack applied to a vehicle body structure according to an embodiment.

The fuel cell stacks 1 are each arranged in the stack mounting portion 79 of the stack mount module 70 configured as shown in FIG. 11.

These fuel cell stacks 1 are engaged to the flanges 79a of the transverse direction support trays 71 by fastening members 96 including a combination of bolts and nuts at the stack mounting portion 79.

The hydrogen tanks 3 are clamped to the strap band clampers 81 of the tank mount module 80 configured as described above.

The configuration and operation of these strap band clampers 81 are obvious to those skilled in the art, and thus a detailed description is omitted.

Hereinafter, the operation of the vehicle body mounting structure of the stack mount module 70 and the tank mount module 80, in which the fuel cell stacks 1 and the hydrogen tanks 3 are mounted as described above, and the vehicle body structure 100 according to an embodiment will be described in detail with reference to FIG. 11.

In an embodiment, the stack mount module 70 and the tank mount module 80 are connected to each other.

The fuel cell stacks 1 are mounted on the stack mount module 70, and the hydrogen tanks 3 are mounted on the tank mount module 80.

The stack mount module 70 engages the front body assembly 11, the side sill 23, and the hydrogen tank mounting unit 50.

The transverse direction support trays 71 of the stack mount module 70 are engaged to the side sill 23 by the fastening members 91.

The front connecting part 76a of the stack mount module 70 is engaged to the front side rear lower member 16 of the front body assembly 11 by the fastening member 92.

The front side rear lower member 16 is connected to the rear of the front side member 12 in a ‘V’ shape along the front-rear direction of the vehicle body.

The rear connecting part 76b of the stack mount module 70 is engaged to the center cross member 53 by the fastening member 93.

Accordingly, the fuel cell stacks 1 mounted on the stack mount module 70 are placed in the fuel cell stack mount space 42 formed at the bottom of the seat mounting member 41 of the fuel cell stack mounting unit 40.

Additionally, the tank mount module 80 is connected to the stack mount module 70 and the hydrogen tank mounting unit 50.

The strap band clampers 81 of the tank mount module 80 are interconnected via the connecting members 83 and the clamper support members 85.

The clamper support member 85 is engaged with the strap band clampers 81 by the fastening member 95.

The strap band clampers 81 are engaged with the transverse direction support tray 71 on the rear side of the stack mount module 70 by the fastening members 94.

The clamper support member 85 is connected to one of the center cross members 53 of the hydrogen tank mounting unit 50 by welding or bolting engagement.

Therefore, the hydrogen tanks 3 are placed in the hydrogen tank mount space 57 formed between the lower surface of the center floor panel 51 of the hydrogen tank mounting unit 50 and the center cross members 53.

Accordingly, according to the vehicle body structure 100 according to an embodiment assembled as described above, the fuel cell stacks 1 may be mounted on the lower part of the seat mounting member 41, and the hydrogen tanks 3 may be mounted on the lower part of the center floor panel 51.

According to the vehicle body structure 100 according to an embodiment described so far, by securing a space for mounting the high-capacity fuel cell stacks 1 and the large-capacity hydrogen tanks 3, a hydrogen electric vehicle-based LCV can be configured without increasing the height of the vehicle body.

In addition, the vehicle body structure 100 according to an embodiment may apply A/S holes to the seat mounting member 41 and the center floor panel 51, thereby securing A/S performance of the fuel cell stacks 1 and the hydrogen tanks 3.

According to the vehicle body structure 100 according to an embodiment, the stack mount module 70 having the fuel cell stacks 1 mounted thereon and the tank mount module 80 having the hydrogen tanks 3 mounted thereon are engaged with the front side rear lower members 16, the side sills 23, and the center cross members 53.

Therefore, the vehicle body structure 100 according to an embodiment can secure mount strength along the vehicle body front-rear direction, the vehicle width direction, and the vertical direction of the fuel cell stacks 1 and hydrogen tanks 3.

Furthermore, the vehicle body structure 100 according to an embodiment forms load paths 99 (see FIG. 2) along the vehicle body front-rear direction and the vehicle width direction by the stack mount module 70 and the tank mount module 80, thereby dispersing the collision load during frontal collision and side collision of the vehicle.

Due to this, the vehicle body structure 100 according to an embodiment can minimize damage to the fuel cell stacks 1 and the hydrogen tanks 3 in the event of a vehicle collision.

While embodiments of this invention have been described in connection with what is presently considered to be practical embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A vehicle body comprising:
a center floor assembly;
a side sill disposed along a front-rear direction of the vehicle body on both sides of the center floor assembly in a vehicle width direction and connected to a front body assembly;
a fuel cell stack mounting apparatus disposed at a front portion of the center floor assembly and configured to position fuel cell stacks at a lower portion of the center floor assembly; and
a hydrogen tank mounting apparatus disposed at a rear of the center floor assembly and configured to position hydrogen tanks at the lower portion of the center floor assembly.

2. The vehicle body of claim 1, wherein the fuel cell stack mounting apparatus comprises a seat mounting member connected to the side sill and to a front side rear lower member, which is connected to a front side member of the front body assembly.

3. The vehicle body of claim 2, wherein the hydrogen tank mounting apparatus comprises:
a center floor panel connected to the seat mounting member and the side sill; and
a plurality of center cross members arranged along the vehicle width direction at predetermined intervals on a lower surface of the center floor panel and connected to the side sill.

4. The vehicle body of claim 3, wherein the seat mounting member is positioned between a front cross member and the center cross members along the vehicle width direction in the front body assembly.

5. The vehicle body of claim 3, wherein the seat mounting member comprises:
a front flange portion connected to a dash panel and the front side rear lower member of the front body assembly;
a rear flange portion connected to the center floor panel; and
a seat mounting portion disposed between the front flange portion and the rear flange portion.

6. The vehicle body of claim 3, wherein a hydrogen tank mount space is defined between the lower surface of the center floor panel and the center cross members.

7. The vehicle body of claim 2, wherein a fuel cell stack mount space is defined at a bottom of the seat mounting member.

8. The vehicle body of claim 2, wherein the seat mounting member is connected to the front side rear lower member, which is arranged in a ‘V’ shape along the front-rear direction of the vehicle body.

9. The vehicle body of claim 1, further comprising:
a stack mount module connected to the front body assembly, the side sill, and the hydrogen tank mounting apparatus and configured to mount the fuel cell stacks to the fuel cell stack mounting apparatus; and
a tank mount module connected to the stack mount module and the hydrogen tank mounting apparatus and configured to mount the hydrogen tanks on the hydrogen tank mounting apparatus.

10. The vehicle body of claim 9, wherein the stack mount module comprises:
a pair of transverse direction support trays arranged along the vehicle width direction at predetermined intervals on a lower side of the fuel cell stack mounting apparatus and engaged with the side sill; and
a longitudinal direction support tray arranged along the front-rear direction of the vehicle body, connected to an upper portion of the transverse direction support trays, and engaged with the front body assembly and the hydrogen tank mounting apparatus.

11. The vehicle body of claim 10, wherein the transverse direction support trays and the longitudinal direction support tray are arranged in an ‘H’ shape and connected by welds.

12. The vehicle body of claim 10, wherein:
each of the transverse direction support trays comprises a transverse direction lower member and a transverse direction upper member connected by welds along a vertical direction to define a first closed space; and
the longitudinal direction support tray comprises a longitudinal direction lower member and a longitudinal direction upper member connected by welds along the vertical direction to define a second closed space.

13. The vehicle body of claim 10, wherein:
a front part of the longitudinal direction support tray is connected to the transverse direction support tray placed in the front by welds; and
a rear part of the longitudinal direction support tray is connected to the transverse direction support tray placed at the rear by welds.

14. The vehicle body of claim 13, wherein the fuel cell stack mounting apparatus comprises a seat mounting member connected to the side sill and to a front side rear lower member, which is connected to a front side member of the front body assembly.

15. The vehicle body of claim 14, wherein the hydrogen tank mounting apparatus comprises:
a center floor panel connected to the seat mounting member and the side sill; and
a plurality of center cross members arranged along the vehicle width direction at predetermined intervals on a lower surface of the center floor panel and connected to the side sill.

16. The vehicle body of claim 15, wherein:
front connecting parts of the longitudinal direction support tray and the transverse direction support tray engage with the front side rear lower member connected to the front side member of the front body assembly; and
rear connecting part of the longitudinal direction support tray and the transverse direction support tray engage with the center cross member disposed in the hydrogen tank mounting apparatus.

17. The vehicle body of claim 10, wherein:
the stack mount module comprises a stack mounting portion partitioned by the transverse direction support trays and the longitudinal direction support tray; and
each of the fuel cell stacks is placed on the stack mounting portion and engages flanges of the transverse direction support trays.

18. The vehicle body of claim 9, wherein:
the fuel cell stack mounting apparatus comprises a seat mounting member connected to the side sill and to a front side rear lower member, which is connected to a front side member of the front body assembly; and
the hydrogen tank mounting apparatus comprises:
a center floor panel connected to the seat mounting member and the side sill; and
a plurality of center cross members arranged along the vehicle width direction at predetermined intervals on a lower surface of the center floor panel and connected to the side sill.

19. The vehicle body of claim 18, wherein the tank mount module comprises a plurality of strap band clampers connected to the stack mount module and connected to the center cross member disposed on the hydrogen tank mounting apparatus.

20. The vehicle body of claim 19, wherein the tank mount module further comprises a clamper support member connected to the strap band clampers and connected to the center cross member.
